(19) United States
(12) Patent Application Publication
(10) Pub. No.: US 2011/0295908 A1
(43) Pub. Date: Dec. 1, 2011

(54) DETECTING COUNTERFEIT DEVICES

(75) Inventors: Dang Tu To, Raleigh, NC (US); Michael C. Elles, Raleigh, NC (US); Eric Thomas Gamble, Raleigh, NC (US); Ketan Bachubhai Patel, Raleigh, NC (US); Rupert P. Walker, Raleigh, NC (US)

(73) Assignee: International Business Machines Corporation, Armonk, NY (US)

(21) Appl. No.: 12/789,137

(22) Filed: May 27, 2010

(51) Int. Cl. G06F 21/00; G06F 15/16; G06F 17/30

(52) U.S. Cl. 707/803; 726/29; 709/217; 707/E17.044

(57) ABSTRACT

A method, system, and computer usable program product for detecting a counterfeit device are provided in the illustrative embodiments. A set of parameters associated with a device is determined. An on-device signature stored on the device is located. A subset of parameters is selected from the set of parameters and a signature is computed using the subset of parameters. The computed signature is compared with the on-device signature. The device is detected as a counterfeit device if the computed signature does not match the on-device signature.

### BACKGROUND OF THE INVENTION

1. Field of the Invention

The present invention relates generally to an improved data processing system, and in particular, to a computer implemented method for managing information about devices in a data processing environment. More particularly, the present invention relates to a computer implemented method, system, and computer usable program code for detecting counterfeit devices in a data processing environment.

2. Description of the Related Art

Today, production and distribution of counterfeit products has become a significant problem in the global marketplace. Almost every country, every region, every industry suffers some loss due to the presence of counterfeit products along with the original products.

A data processing system of any type invariably includes components or devices. Counterfeiting is a prevalent problem with respect to the devices used in data processing systems as well. An original device is a device manufactured, distributed, sold, or consumed according to the instructions of the rightful manufacturer of the device. A counterfeit device is a device that is not an original device. For example, a device that is a copy or a replica of an original device, intended for distribution, sale, or consumption as the original device, without the authorization of the manufacturer of the original device, is a counterfeit device. As another example, an original device that is distributed, sold, or consumer outside a licensed production quota suggested by the manufacturer of the original device may also be considered a counterfeit device.

The adverse effects of counterfeit products are diverse and far-reaching. Some anti-counterfeit solutions currently exist in the market. However, none of these solutions provides a robust enough method to reduce or eliminate the manufacture and distribution of counterfeit devices. For example, a counterfeit device may cause the reliability of the data processing system where the counterfeit device may be installed to become unacceptable. As another example, a counterfeit device may not meet performance requirements or design specifications, causing a data processing system or an application executing thereon to fail.

The effects of counterfeiting can be direct or indirect. For example, harm to equipment, loss of goodwill, and loss of revenue are some of the direct problems associated with counterfeiting. Disruption of essential services, disruption of business critical operations, and creation of hazardous conditions during the use of an equipment are some of the indirect consequences of counterfeiting.

### SUMMARY OF THE INVENTION

The illustrative embodiments provide a method, system, and computer usable program product for detecting counterfeit devices. An embodiment determines at an application executing in a data processing system, a set of parameters associated with a device. The embodiment locates an on-device signature stored on the device. The embodiment selects a subset of parameters from the set of parameters and computes a signature using the subset of parameters forming a computed signature. The embodiment compares the computed signature with the on-device signature and detects the device as the counterfeit device if the computed signature does not match the on-device signature.

### BRIEF DESCRIPTION OF THE DRAWINGS

The novel features believed characteristic of the invention are set forth in the appended claims. The invention itself; however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the illustrative embodiments may be implemented;

FIG. 2 depicts a block diagram of a data processing system in which the illustrative embodiments may be implemented;

FIG. 3 depicts a block diagram of an example device with respect to which an illustrative embodiment may be implemented;

FIG. 4 depicts a block diagram of a signature generation application in accordance with an illustrative embodiment;

FIG. 5 depicts a block diagram of another example signature generation application in accordance with an illustrative embodiment;

FIG. 6 depicts a block diagram of a modified device in accordance with an illustrative embodiment;

FIG. 7 depicts a configuration of a data processing system in which a counterfeit device may be detected in accordance with an illustrative embodiment;

FIG. 8 depicts a block diagram of other features of a device that may be modified for detecting counterfeit devices in accordance with an illustrative embodiment;

FIG. 9 depicts a flowchart of an example process for creating an on-device signature that can be used for detecting counterfeit devices in accordance with an illustrative embodiment;

FIG. 10 depicts a flowchart of an example process for creating a label that can be used for detecting counterfeit devices in accordance with an illustrative embodiment; and

FIG. 11 depicts a flowchart of an example process for detecting counterfeit devices in accordance with an illustrative embodiment.

### DETAILED DESCRIPTION OF THE PREFERRED EMBODIMENT

The invention recognizes that the introduction of counterfeit devices begins with the manufacturing of the counterfeit devices. The invention further recognizes that the detection of counterfeit devices is often a non-trivial task. For example, presently, a largely manual process is used to identify a counterfeit device. Furthermore, the present process is initiated upon often coincidental and sometimes deliberate revelation of a device that may be counterfeit.

For example, the invention recognizes that a common data processing system is often assembled from parts sourced from manufacturers, consolidators, and other intermediary suppliers. Given that an ordinary data processing system includes numerous parts, and is often manufactured in a highly automated environment, the invention recognizes the difficulty and counter-productiveness of searching for counterfeits in a sea of devices.

Labels that are difficult to copy, holograms, product registration systems, and bar codes are some example solutions that are presently used to address counterfeiting of devices to some extent. However, the invention recognizes that present solutions do not provide an adequate method to deal with detecting a counterfeit products once installed in a data processing system. The invention also recognizes that the present methods are insufficient to answer a simple question—is the device in question a counterfeit device?—especially when the visual clues associated with the counterfeit devices are becoming increasingly improved copies of the original visual information of the original devices.

The illustrative embodiments used to describe the invention generally address and solve the above-described problems and other problems related to counterfeit devices. The illustrative embodiments of the invention provide a method, computer usable program product, and data processing system for detecting counterfeit devices before their introduction in a data processing environment, and after their installation in a data processing system. An embodiment of the invention also enables modifying the original devices at the time of manufacture in a manner that a counterfeit device attempting to masquerade as the original device can be detected using an illustrative embodiment.

Generally, within the scope of the invention, a device may be a single unit or a group of units to be manufactured, packaged, sold, installed, or otherwise used together. A customer or consumer is any entity that buys or otherwise procures a device. A producer or manufacturer is any entity that manufactures, packages, or otherwise acts as a source for a device.

The illustrative embodiments are described with respect to data, data structures, and identifiers only as examples. Such descriptions are not intended to be limiting on the invention. For example, an illustrative embodiment described with respect to single piece of information may be implemented using a combination of several pieces of information, in a similar manner within the scope of the invention.

Furthermore, the illustrative embodiments may be implemented with respect to any type of data processing system. For example, an illustrative embodiment described with respect to a single-processor standalone data processing system may be implemented in a multiprocessor logical partition system, or any other organization of data processing systems, such as rack configurations in a data center, within the scope of the invention. As another example, an embodiment of the invention may be implemented with respect to any type of client system, server system, platform, or a combination thereof.

The illustrative embodiments are further described with respect to certain parameters, attributes, and configurations only as examples. Such descriptions are not intended to be limiting on the invention. For example, an illustrative embodiment described with respect to numeric attribute may be implemented using an alphanumeric attribute, a symbolic attribute, or a combination thereof, in a similar manner within the scope of the invention.

An application implementing an embodiment may take the form of data objects, code objects, encapsulated instructions, application fragments, drivers, routines, services, systems—including basic I/O system (BIOS), and other types of software implementations available in a data processing environment. For example, Java® Virtual Machine (JVM®), Java® object, an Enterprise Java Bean (EJB®), a servlet, or an applet may be manifestations of an application with respect to which, within which, or using which, the invention may be implemented. (Java, JVM, EJB, and other Java related terminologies are registered trademarks of Sun Microsystems, Inc. in the United States and other countries.)

An illustrative embodiment may be implemented in hardware, software, or a combination thereof. The examples in this disclosure are used only for the clarity of the description and are not limiting on the illustrative embodiments. Additional or different information, data, operations, actions, tasks, activities, and manipulations will be conceivable from this disclosure for similar purpose and the same are contemplated within the scope of the illustrative embodiments.

The illustrative embodiments are described using specific code, data structures, file systems, designs, architectures, layouts, schematics, and tools only as examples and are not limiting on the illustrative embodiments. Furthermore, the illustrative embodiments are described in some instances using particular data processing environments only as an example for the clarity of the description. The illustrative embodiments may be used in conjunction with other comparable or similarly purposed structures, systems, applications, or architectures.

Any advantages listed herein are only examples and are not intended to be limiting on the illustrative embodiments. Additional or different advantages may be realized by specific illustrative embodiments. Furthermore, a particular illustrative embodiment may have some, all, or none of the advantages listed above.

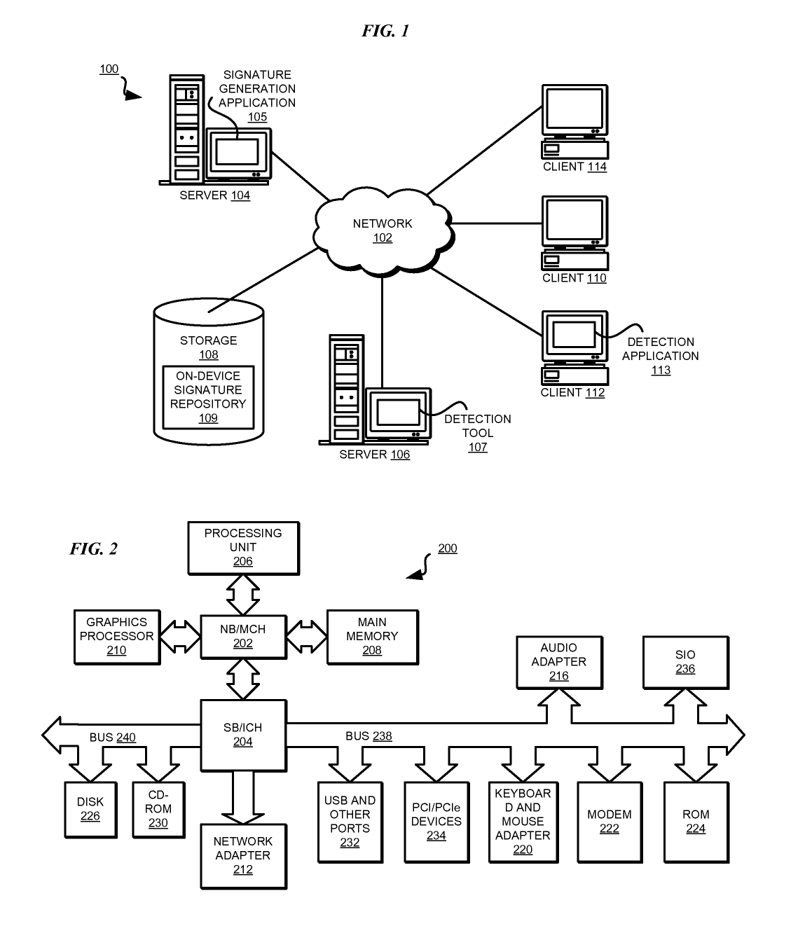

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

Server 104 may include signature generation application 105. Signature generation application 105 may generate a signature for an original device according to an embodiment described herein. Server 106 may include detection tool 107. Detection tool 107 may be one form an application implementing an illustrative embodiment. For example, detection tool 107 may be part of server 106's BIOS. Storage 108 may include repository 109. Repository 109 may be an on-device signature repository in accordance with an embodiment described herein. Client 112 may include detection application 113. Detection application 113 may be a different form of an application implementing an illustrative embodiment. For example, detection tool 113 may be an application usable in conjunction with a diagnostic tool installed on client 112.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client server environment in which the illustrative embodiments may be implemented. A client server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including North Bridge and memory controller hub (NB/MCH) 202 and south bridge and input/output (I/O) controller hub (SB/ICH) 204. Processing unit 206, main memory 208, and graphics processor 210 are coupled to north bridge and memory controller hub (NB/MCH) 202. Processing unit 206 may contain one or more processors and may be implemented using one or more heterogeneous processor systems. Graphics processor 210 may be coupled to the NB/MCH through an accelerated graphics port (AGP) in certain implementations. In some configurations, processing unit 206 may include NB/MCH 202 or parts thereof.

In the depicted example, local area network (LAN) adapter 212 is coupled to south bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238. Hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). In some configurations, ROM 224 may be an Electrically Erasable Programmable Read-Only Memory (EEPROM) or any other similarly usable device. Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub (SB/ICH) 204.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java is a trademark of Sun Microsystems, Inc., in the United States and other countries).

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in north bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

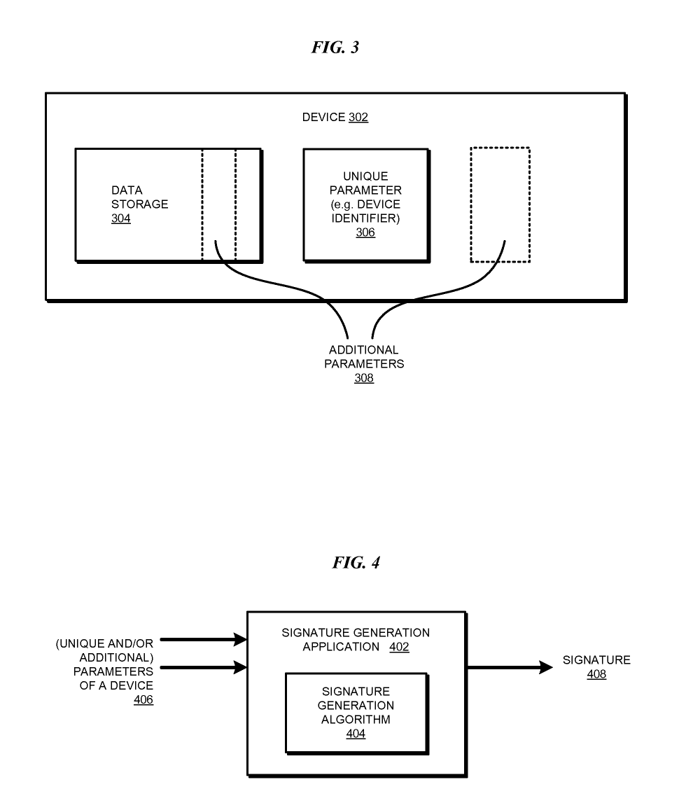

With reference to FIG. 3, this figure depicts a block diagram of an example device with respect to which an illustrative embodiment may be implemented. Device 302 may be any device usable in a data processing system or another system. For example, an automobile may include components that are capable of storing data. Such components may also be manifestations of device 302 within the scope of the invention. Generally, any device capable of storing data items according to an embodiment described herein may be represented by device 302 within the scope of the invention.

Some more examples of device 302, such as those usable with some manifestation of a data processing system, may be a memory module usable as main memory 208 or ROM 224 in FIG. 2, a hard disk drive or a solid-state drive usable as disk 226 in FIG. 2, a processor usable as processing unit 206 in FIG. 2. Device 302 may also be a part of a component of a data processing system. For example, device 302 may be an integrated circuit used in a circuit board, such as audio adapter 216 in FIG. 2 or a graphics adapter including graphics processor 210 in FIG. 2, or a component usable at USB and other ports 232 in FIG. 2. Device 302 may also be a circuit board itself within the scope of the invention.

Device 302 includes data storage 304. Data storage 304 may be any structure suitable for storing data on device 302.

Device 302 further includes unique parameter 306. Unique parameter 306 may be any identifier capable of uniquely identifying device 302 in a collection of devices. As an example, unique parameter 306 may be a serial presence detect value (SPD) that is present on some devices. As another example, unique parameter 306 may be a serial number associated with device 302.

Furthermore, unique parameter 306 may include more than one identifier, which when used in some combination uniquely identify device 302. For example, unique parameter 306 may include a serial number, an identifier identifying the manufacturer of device 302, and a batch number identifying the production run when device 302 was produced.

Additional parameters 308 may be a set of other identifiers associated with device 302. A set of identifiers or parameters is one or more identifiers or parameters. Additional parameters 308 may be usable for any purpose with respect to device 302. For example, additional parameters 308 may include an identifier identifying a type associated with device 302. As another example, additional parameters 308 may include an identifier used as a code to associate device 302 with a certain component or subsystem.

The examples of unique parameter 306 and additional parameters 308 are not intended to be limiting on the invention. Many other identifiers, attributed, or parameters associated with device 302 and usable as unique parameter 306 or additional parameters 308 will be apparent to those of ordinary skill in the art and the same are contemplated within the scope of the invention.

Furthermore, unique parameter 306, additional parameters 308, or a combination thereof may be located or stored anywhere on device 302, including in data storage 304, without limitation. Only as an example, FIG. 3 depicts unique parameter 306 as being stored in a location separate from data storage 304. Some additional parameters 308 are shown as being stored in data storage 304 and some additional parameters 308 are shown as being stored in a location separate from data storage 304 also only as examples without limiting the invention.

Additionally, in one embodiment, data storage 304, and other data storage usable for storing unique parameter 306 or additional parameters 308 may be able to persist data stored therein without requiring continuous availability of electrical power. In other words, non-volatile memory or another similarly usable data storage device that does not require active power source to maintain data stored therein may be used as data storage 304 and other data storage for storing unique parameter 306 or additional parameters 308.

With reference to FIG. 4, this figure depicts a block diagram of a signature generation application in accordance with an illustrative embodiment. Signature generation application 402 may be used as signature generation application 105 in FIG. 1.

Signature generation application 402 uses signature generation algorithm 404. Algorithm 404 may be any algorithm suitable for combining parameters 406 to result in signature 408. Parameters 406 may be a combination of a unique parameter and any number of additional parameters associated with a device. Signature 408 may be an identifier of any form or type computed using algorithm 404 on a combination of parameters 406. As an example, signature 408 may be a hash value or a checksum of one or more parameters 404, other attributes or strings of choice, or a combination thereof.

In one embodiment, signature generation application 402 may be provided to a manufacturer of original devices. The manufacturer may input parameters 406 of an original device to be manufactured into application 402 and receive signature 408. The manufacturer may associate signature 408 with the original device according to an illustrative embodiment described herein.

With reference to FIG. 5, this figure depicts a block diagram of another example signature generation application in accordance with an illustrative embodiment. Signature generation application 502 may be used as signature generation application 105 in FIG. 1.

Signature generation application 502 uses signature generation algorithm 504. Algorithm 504 may be any algorithm suitable for combining parameters 506 with key 508 to result in signature 510. Parameters 506 may be similar to parameters 406 in FIG. 4.

Key 508 may be an identifier of any form or type suitable for use with algorithm 504. As an example, key 508 may be an encryption key that may encrypt a combination of parameters 506 to result in signature 510. As another example, key 508 may be a hash value or a checksum of one or more identifiers, parameters, attributes, or strings of choice. Signature 510 may be an identifier of any form or type computed using algorithm 504 on a combination of parameters 506 and key 508.

In one embodiment, signature generation application 502 may be provided to a manufacturer of original devices. The manufacturer may input parameters 506 of an original device to be manufactured into application 502. Key 508 may be provided to the manufacturer or the manufacturer may generate key 508. Application 502 outputs signature 510, which the manufacturer may associate with the original device according to an illustrative embodiment described herein.

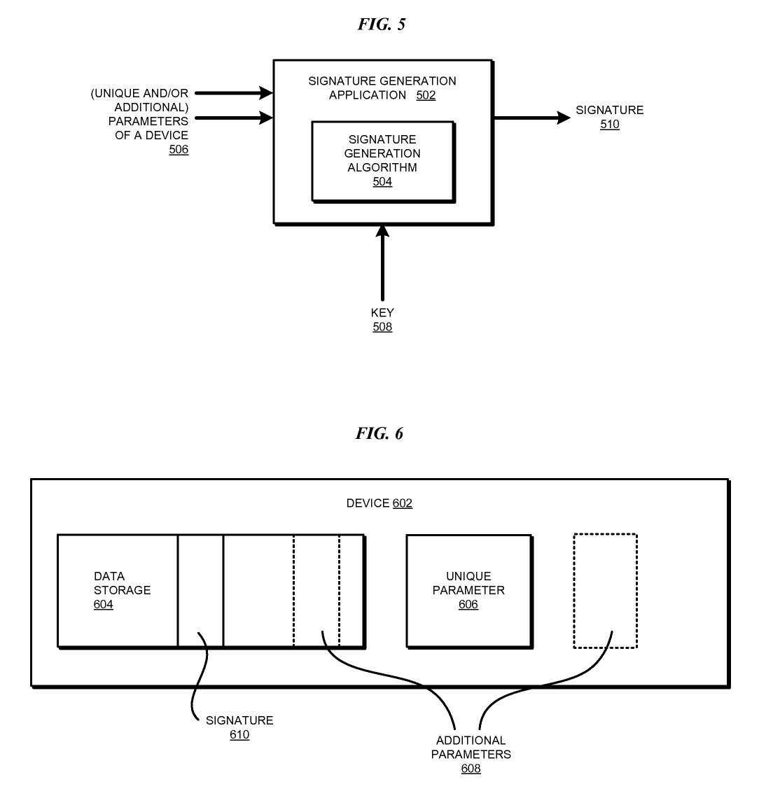

With reference to FIG. 6, this figure depicts a block diagram of a modified device in accordance with an illustrative embodiment. Device 602 may include a modification of device 302 in FIG. 3. Data storage 604, unique parameter 606, and additional parameters 608 may be similar to data storage 304, unique parameter 306, and additional parameters 308 respectively in FIG. 3.

Signature 610 may be similar to signature 408 in FIG. 4 or signature 510 in FIG. 5. Signature 610 may be stored in any suitable location in data storage 604 without limitation.

In one embodiment, signature 60 may be stored in the free or available location in data storage 604. In some devices, such free or available location may be towards the end of data storage 604. In another embodiment, such as when no free location is available in data storage 604, signature 610 may be combined with some existing data in data storage 604 such that the data and the signature can be separated when needed.

Signature 610 stored in device 602 forms an on-device signature. Using a detection tool, such as detection tool 107 in FIG. 1, or a detection application, such as detection application 113 in FIG. 1, the on-device signature 610 can be used to verify the authenticity of device 602. Because the signature is generated using a set of parameters, one or more keys, a signature generation algorithm, or a combination thereof, known to the manufacturer of the original device but not to a counterfeiter, a counterfeit device may not include the correct signature for the correct set of parameters in a counterfeit device. Thus, a detection tool or application according to an embodiment may detect a device that includes an incorrect signature for the given set of parameters, or an incorrect set of parameters for a given signature, as a counterfeit device.

Furthermore, a counterfeiter may not be able to determine the correct location of the on-device signature on the device. Therefore, even if the set of parameters, one or more keys, and the signature generation algorithm become known to a counterfeiter, the location of the signature is another variable that may assist a detection tool or application according to an embodiment in detecting a counterfeit device even when the counterfeit device includes the correct set of parameters and the correct signature.

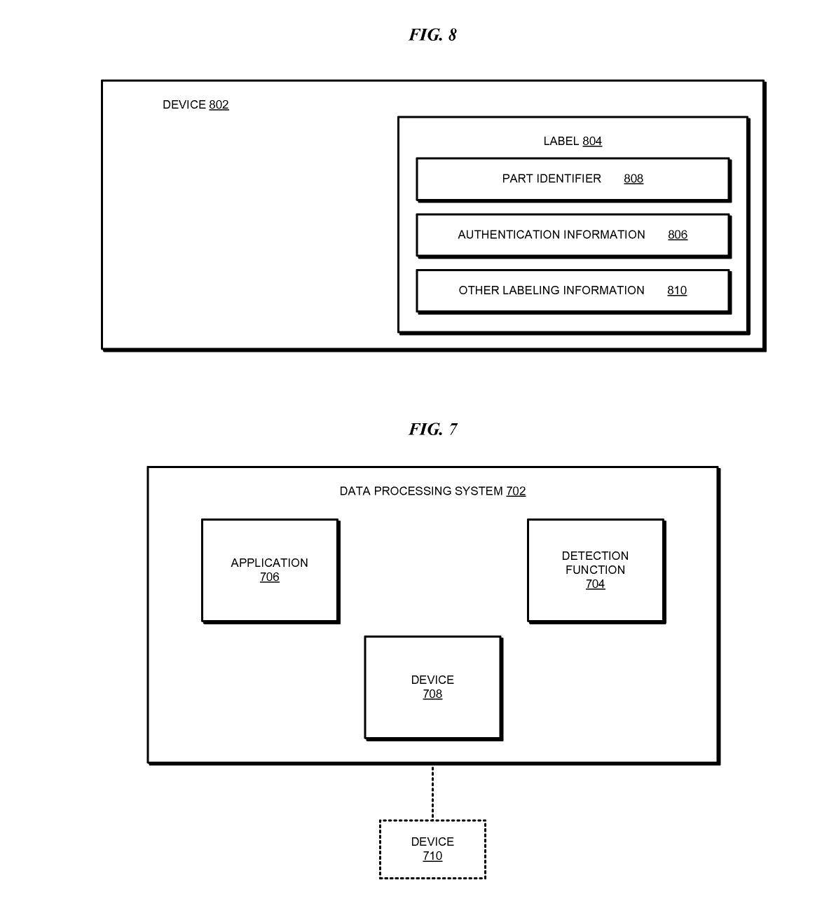

With reference to FIG. 7, this figure depicts a configuration of a data processing system in which a counterfeit device may be detected in accordance with an illustrative embodiment. Data processing system 702 may be any data processing system, such as server 106 or client 112 in FIG. 1. Detection function 704 may be implemented as detection tool 107 or detection application 113 in FIG. 1. Application 706 may be an existing application, such as an operating system or a diagnostic tool.

Device 708 may be similar to device 602 in FIG. 6. Device 708 may be installed in data processing system 702 at any point in time. For example, in one embodiment, device 708 may be installed in data processing system 702 before data processing system 702 is booted up. In another embodiment, device 708 may be a hot pluggable (or hot swappable) device that may be introduced in data processing system 702 during data processing system's operation.

In one embodiment, device 708 may be coupled with data processing system 702 in the form of device 710. For example, if data processing system 702 is a diagnosis station used to verify authenticity of various devices, device 710 may be coupled with data processing system 702 for that purpose using suitable interface.

Detection function 704, alone or in conjunction with application 706, may detect the authenticity of device 708 or 710. For example, detection function 704 may transmit an on-device signature found on device 708 or 710 to an external repository, such as on-device signature repository 109 in FIG. 1, for verification.

Detection function 704, alone or in conjunction with application 706, may detect device 708 or 710 as a counterfeit device, and may take a suitable further action. For example, a log may be updated with the on-device signature found on device 708 or 710. As another example, an execution of an application may be halted or altered. As another example, a configuration of data processing system 702 may be modified to operate while excluding device 708 or 710. As another example, an administrator or a manufacturer may be notified. As another example, a repository, such as on-device signature repository 109 in FIG. 1, may be updated with the on-device signature of counterfeit device 708 or 710. Detection function 704 may perform or trigger any suitable action in a given implementation without departing the scope of the invention.

With reference to FIG. 8, this figure depicts a block diagram of other features of a device that may be modified for detecting counterfeit devices in accordance with an illustrative embodiment. Device 802 may be similar to device 602 in comparing the internal contents of device 802.

In one embodiment, label 804 may be a visually or tactically perceptible label affixed to device 802. In another embodiment, label 804 may be a radio frequency identification (RFID) tag printed or affixed on device 802. Label 804 may take any suitable form so long as label 804 can store, depict, or otherwise provide authentication information 806 usable according to an illustrative embodiment. For example, in one embodiment, label 804 may be more than one label of different types—one label depicting part identifier 808 and other label information 810 in printed form, and another RFID tag label providing authentication information 806.

Authentication information 806 may be derived from a subset of parameters, such as a subset of parameters 506 in FIG. 5, a signature, such as signature 610 in FIG. 6, or a combination thereof. For example, in one embodiment, authentication information 806 may simply be a concatenated string formed using a unique parameter and the on-device signature associated with device 802. The string may be represented as plain text, a bar code, RFID data readout, or any other form of authentication information 806.

In another example, authentication information 806 may be an encoded form of the on-device signature associated with device 802. The encoded data may be represented as plain text, a bar code, RFID data readout, or any other form of authentication information 806.

Part identifier 808 may be any existing information usable for identifying device 802. For example, part identifier 808 may be a unique identifier associated with device 802.

Part identifier 808 may be optionally affixed to device 802, such as for the continuity of those processes that depend on part identifier 808′s availability. Other labeling information 810 may be any other labeling information as may be needed in a particular implementation, such as for the continuity of those processes that depend on information 810′s availability.

With reference to FIG. 9, this figure depicts a flowchart of an example process for creating an on-device signature that can be used for detecting counterfeit devices in accordance with an illustrative embodiment. Process 900 may be implemented as a signature generation application, such as signature generation application 402 in FIG. 4 or 502 in FIG. 5.

Process 900 begins by receiving a set of parameters associated with a device (step 902). In one embodiment, the set of parameters includes a unique parameter.

Process 900 may optionally receive a key (step 904). For example, in one embodiment, process 900 may be implemented as signature generation application 502 in FIG. 5 and may use a key for generating a signature. In another embodiment, process 900 may be implemented as signature generation application 402 in FIG. 4 and may not use a key for generating a signature.

Process 900 generates a signature using some or all of the parameters in the set, and one or more keys if available (step 906). Process 900 determines a location on the device to store the signature (step 908).

Process 900 stores the signature generated in step 906 in the form of on-device signature at the location identified in step 908 (step 910). Process 900 may end thereafter. In one embodiment, process 900 may exit at exit point marked “A” and enter another process having a corresponding entry point “A”.

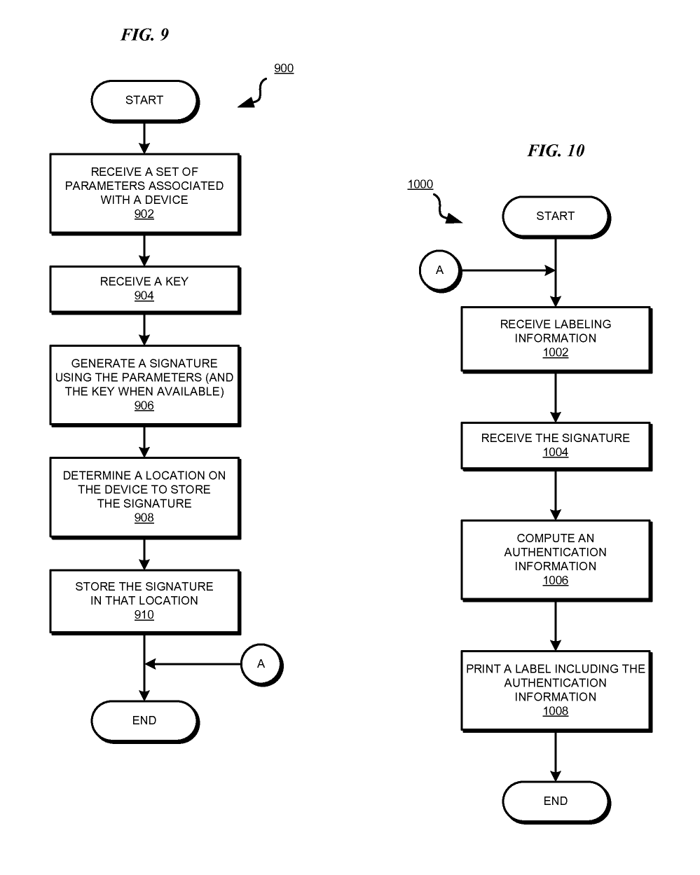

With reference to FIG. 10, this figure depicts a flowchart of an example process for creating a label that can be used for detecting counterfeit devices in accordance with an illustrative embodiment. Process 1000 may be implemented as a part of a signature generation application, such as signature generation application 402 in FIG. 4 or 502 in FIG. 5.

Process 1000 begins by receiving labeling information (step 1002). Another process, such as process 900 in FIG. 9, may also enter process 1000 at step 1002 via entry point marked “A”.

Labeling information may include any information needed for suitably labeling a device in a given implementation. For example, labeling information received in step 1002 may include part identifier 808 and other labeling information 810 in FIG. 8.

Process 1000 receives a signature (step 1004). Signature received in step 1004 may be a signature generated at step 906 in process 900 in FIG. 9.

Process 1000 computes an authentication information from a combination of the labeling information of step 1002 and the signature of step 1004 (step 1006). Authentication information of step 1006 may be used as authentication information 806 in FIG. 8. As described with respect to FIG. 8, authentication information of step 1006 may be any representation of un-encoded or encoded form of any combination of a portion of the labeling information and the signature.

Process 1000 prints a label including the authentication information (step 1008). Process 1000 ends thereafter.

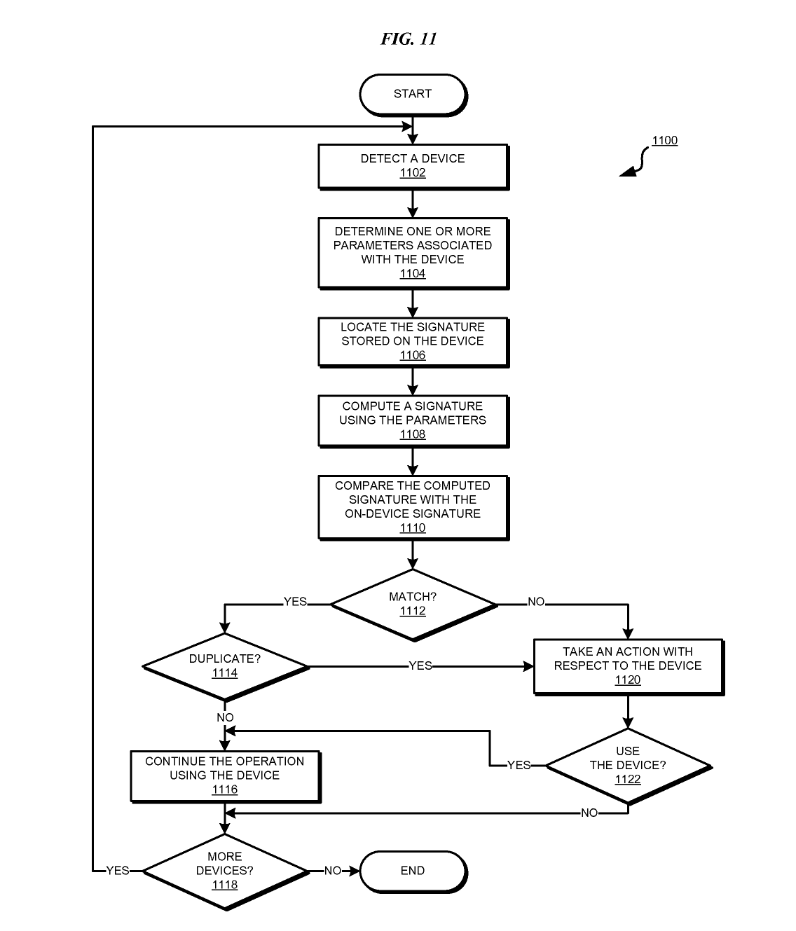

With reference to FIG. 11, this figure depicts a flowchart of an example process for detecting counterfeit devices in accordance with an illustrative embodiment. Process 1100 may be implemented as detection function 704 in FIG. 7.

Process 1100 begins by detecting a device (step 1102). Process 1100 determines one or more parameters associated with the device (step 1102). For example, process 1100 may determine a unique parameter associated with the device.

Process 1100 locates the signature stored on the device (step 1106). In one embodiment, process 1100 may use logic or knowledge embedded in the detection function to determine the location. In another embodiment, process 1100 may be supplied with the location from another source, such as a manufacturer's secure server or an on-device signature repository.

Process 1100 computes a signature using a subset of the parameters (step 1108). In one embodiment, process 1100 may use logic or knowledge embedded in the detection function to determine which subset to use in the computation and how to perform the computation. In another embodiment, process 1100 may be supplied with such information from another source, such as a manufacturer's secure server or an on-device signature repository.

Process 1100 compares the computed signature with the on-device signature (step 1110). Process 1100 determines whether the computed signature and the on-device signature match (step 1112).

If the two signatures match (“Yes” path of step 1112), process 1100 further determines whether the on-device signature is a duplicate (step 1114). A duplicate on-device signature is an signature that appears as on-device signature in two or more devices. A signature is preferably associated uniquely with a device for the device to be an original device.

If process 1100 determines that the on-device signature is not a duplicate (“No” path of step 1114), process 1100 allows an operation of the data processing system associated with the detection function to continue (step 1116).

Process 1100 determines whether more devices are to be authenticated, or in other words, more counterfeit devices are to be detected (step 1118). If more devices are to be detected or authenticated, (“Yes” path of step 1118, process 1100 returns to step 1102. If no more devices remain to be detected or authenticated (“No” path of step 1118), process 1100 ends thereafter.

Returning to step 1112, if the two signatures do not match (“No” path of step 1112), process 1100 may deem the device a counterfeit device and take an action with respect to the device (step 1120). Some examples of the possible actions are described with respect to detection function 704 in FIG. 7.

Process 1100 may determine whether to use the counterfeit device (step 1122). If the device is to be used (“Yes” Path of step 1122), process 1100 returns to step 1116. If the device is not to be used (“No” Path of step 1122), process 1100 returns to step 1118.

The components in the block diagrams and the steps in the flowcharts described above are described only as examples. The components and the steps have been selected for the clarity of the description and are not limiting on the illustrative embodiments of the invention. For example, a particular implementation may combine, omit, further subdivide, modify, augment, reduce, or implement alternatively, any of the components or steps without departing from the scope of the illustrative embodiments. Furthermore, the steps of the processes described above may be performed in a different order within the scope of the invention.

Thus, a computer implemented method, apparatus, and computer program product are provided in the illustrative embodiments for detecting counterfeit devices. Using an embodiment of the invention, counterfeit device may be detected at or before the time of introduction of the device into a data processing environment.

An embodiment may allow detection of counterfeit devices, such as by detecting duplicate on-device signatures, by maintaining a local repository of on-device signatures. Such an embodiment may be useful in large data processing environments, such as a data center with numerous devices of similar type in use. For example, advantageously, a group of systems may coordinate among themselves to determine if one or more devices present in the group are counterfeit devices.

In one embodiment, one system in the group may host a repository of on-device signatures and all systems in the group may consult that repository for making such a determination. In another embodiment, systems in a group or a data processing environment may utilize a repository external to the group of environment for making similar determinations within the scope of the invention.

An embodiment may allow detection of counterfeit devices, such as by detecting duplicate on-device signatures by utilizing remote repositories of on-device signatures or remote validation of on-device signatures. For example, an on-device signature repository may act as a on-device signature validation service. Such an embodiment may be useful in small data processing environments, such as, for example, a standalone data processing system with one or two devices of a particular type.

Advantageously, using an embodiment, a system may be able to determine that a counterfeit device is included in the system. A system may also be able to determine if two or more devices included therein may be suspect counterfeit devices for having similar signatures.

Although the embodiments are described using examples of data processing systems and devices or components of data processing systems, such examples are not limiting on the invention. An embodiment may be implemented in any device capable of storing data, and in any system where such device may be used within the scope of the invention. Some examples of other types of devices within the scope of the invention may be controller modules, sensors, and other electromechanical components. Such devices may be usable in conjunction with automobiles, engineering equipment, machinery, or tools within the scope of the invention.

The invention can take the form of an entirely software embodiment, or an embodiment containing both hardware and software elements. In a preferred embodiment, the invention is implemented in software or program code, which includes but is not limited to firmware, resident software, and microcode.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage media, and cache memories, which provide temporary storage of at least some program code in order to reduce the number of times code must be retrieved from bulk storage media during execution.

A data processing system may act as a server data processing system or a client data processing system. Server and client data processing systems may include data storage media that are computer usable, such as being computer readable. A data storage medium associated with a server data processing system may contain computer usable code. A client data processing system may download that computer usable code, such as for storing on a data storage medium associated with the client data processing system, or for using in the client data processing system. The server data processing system may similarly upload computer usable code from the client data processing system. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

What is claimed is:

1. A computer implemented method for detecting a counterfeit device, the computer implemented method comprising:
determining at an application executing in a data processing system, a set of parameters associated with a device;
locating an on-device signature stored on the device;
selecting a subset of parameters from the set of parameters;
computing a signature using the subset of parameters, the signature forming a computed signature;
comparing the computed signature with the on-device signature; and
detecting the device as the counterfeit device responsive to the computed signature not matching the on-device signature.

2. The computer implemented method of claim 1, further comprising:
determining a duplicate by determining whether the on-device signature is available on a plurality of devices; and
identifying the device as the counterfeit device responsive to the on-device signature being available on the plurality of devices.

3. The computer implemented method of claim 2, wherein determining the duplicate is based on information received from an on-device signature repository, the information revealing that the on-device signature is available on the plurality of devices.

4. The computer implemented method of claim 1, further comprising:
taking an action responsive to the detecting.

5. The computer implemented method of claim 4, wherein the action comprises:
updating an on-device signature repository with the on-device signature of the counterfeit device.

6. The computer implemented method of claim 1, wherein the location is provided by an on-device signature validation service.

7. The computer implemented method of claim 6, wherein the on-device signature validation service is an on-device signature repository.

8. The computer implemented method of claim 1, wherein the subset of parameters is identified by an on-device signature validation service.

9. The computer implemented method of claim 1, wherein the set of parameter includes a unique parameter associated with the device.

10. The computer implemented method of claim 1, further comprising:
detecting the device when the device is introduced into the data processing system during the operation of the data processing system.

11. A computer usable program product comprising a computer usable storage medium including computer usable code for detecting a counterfeit device, the computer usable code comprising:
computer usable code for determining at an application executing in a data processing system, a set of parameters associated with a device;
computer usable code for locating an on-device signature stored on the device;
computer usable code for selecting a subset of parameters from the set of parameters;
computer usable code for computing a signature using the subset of parameters, the signature forming a computed signature;
computer usable code for comparing the computed signature with the on-device signature; and
computer usable code for detecting the device as the counterfeit device responsive to the computed signature not matching the on-device signature.

12. The computer usable program product of claim 11, further comprising:
computer usable code for determining a duplicate by determining whether the on-device signature is available on a plurality of devices; and
computer usable code for identifying the device as the counterfeit device responsive to the on-device signature being available on the plurality of devices.

13. The computer usable program product of claim 12, wherein determining the duplicate is based on information received from an on-device signature repository, the information revealing that the on-device signature is available on the plurality of devices.

14. The computer usable program product of claim 11, wherein the location is provided by an on-device signature validation service.

15. The computer usable program product of claim 11, wherein the set of parameter includes a unique parameter associated with the device.

16. The computer usable program product of claim 11, further comprising:
computer usable code for detecting the device when the device is introduced into the data processing system during the operation of the data processing system.

17. The computer usable program product of claim 11, wherein the computer usable code is stored in a computer readable storage medium in a data processing system, and wherein the computer usable code is transferred over a network from a remote data processing system.

18. The computer usable program product of claim 11, wherein the computer usable code is stored in a computer readable storage medium in a server data processing system, and wherein the computer usable code is downloaded over a network to a remote data processing system for use in a computer readable storage medium associated with the remote data processing system.

19. A data processing system for detecting a counterfeit device, the data processing system comprising:
a storage device including a storage medium, wherein the storage device stores computer usable program code; and
a processor, wherein the processor executes the computer usable program code, and wherein the computer usable program code comprises:
computer usable code for determining at an application executing in a data processing system, a set of parameters associated with a device;
computer usable code for locating an on-device signature stored on the device;
computer usable code for selecting a subset of parameters from the set of parameters;
computer usable code for computing a signature using the subset of parameters, the signature forming a computed signature;
computer usable code for comparing the computed signature with the on-device signature; and
computer usable code for detecting the device as the counterfeit device responsive to the computed signature not matching the on-device signature.

20. The data processing system of claim 19, further comprising:
computer usable code for determining a duplicate by determining whether the on-device signature is available on a plurality of devices; and
computer usable code for identifying the device as the counterfeit device responsive to the on-device signature being available on the plurality of devices.
